(19) United States
(12) Patent Application Publication
(10) Pub. No.: US 2025/0112472 A1
(43) Pub. Date: Apr. 3, 2025

(54) SCALABLE CHARGER ARCHITECTURE

(71) Applicant: Apple Inc., Cupertino, CA (US)

(72) Inventors: Stefano Scaldaferri, Bientina (IT); Pietro Gabriele Gambetta, Livorno (IT); Enrico Zanetti, Cascina (IT)

(21) Appl. No.: 18/770,284

(22) Filed: Jul. 11, 2024

Related U.S. Application Data
(60) Provisional application No. 63/586,077, filed on Sep. 28, 2023.

(51) Int. Cl. H02J 7/00

(52) U.S. Cl. CPC H02J 7/00047; H02J 7/00032; H02J 7/0029; H02J 7/0047; H02J 7/0013; H02J 2207/20

(57) ABSTRACT

A scalable battery charger can include a leader charger and at least one follower charger. The leader can include: a DC-DC converter leader phase that receives an input voltage and operates one or more switching devices to generate a regulated output; leader control circuitry that operates the DC-DC converter leader phase to regulate the output; and a leader-follower communication interface that couples the leader control circuitry to the at least one follower charger. The at least one follower charger can include: one or more DC-DC converter follower phases that receive an input voltage and operate one or more switching devices to generate a regulated output; follower control circuitry that operates the one or more DC-DC converter follower phases to regulate the follower output; and a leader-follower communication interface that couples the follower control circuitry to the leader charger.

### CROSS-REFERENCE TO RELATED APPLICATIONS

This patent application claims priority to co-pending U.S. Provisional Patent Application 63/586,077, entitled “Scalable Charger Architecture,” filed Sep. 28, 2023, which is hereby incorporated by reference.

### BACKGROUND

Many types of electronic devices incorporate batteries and thus have need for battery charging circuits. Traditionally, such battery charger circuits have been selected on a per-device basis, with different types of devices using chargers of different capacities and/or capabilities.

### SUMMARY

In some applications it may be desirable to provide a scalable battery charger architecture in which a leader charger and optionally one or more follower chargers can be provided to accommodate the different battery charger requirements of different types of electronic devices while maintaining a common architecture and control.

A scalable battery charger system can include a leader charger and at least one follower charger. The leader charger can include an input that receives at least one leader input voltage; a DC-DC converter leader phase that receives the at least one input voltage and operates one or more switching devices of the DC-DC converter leader phase to generate a regulated leader output in cooperation with one or more external components coupled to the leader charger; leader control circuitry that operates the DC-DC converter leader phase to regulate the output; and a leader-follower communication interface that couples the leader control circuitry to at least one follower charger. The at least one follower charger can include an input that receives at least one follower input voltage; one or more DC-DC converter follower phases that receive the at least one follower input voltage and operates one or more switching devices of the DC-DC converter follower phases to generate a regulated output in cooperation with one or more external components coupled to the at least one follower charger; follower control circuitry that operates the one or more DC-DC converter follower phases to regulate the follower output; and a leader-follower communication interface that couples the follower control circuitry to the leader charger. The scalable battery charger system can further include at least one battery pack, the at least one battery pack further including: a battery having one or more cells; and a protection switch.

The leader charger can further include linear charging control circuitry that controls a charging transistor coupled between the leader output and the at least one battery pack; and battery current sensing circuitry coupled to at least one current sensor coupled in series with the at least one battery pack. The DC-DC converter leader phase can be selected from the group consisting of: a buck converter, a boost converter, a buck-boost converter, and a charge pump. The one or more external components coupled to the leader charger can include at least one inductor or at least one capacitor. The at least one DC-DC converter follower phase can be selected from the group consisting of: a buck converter, a boost converter, a buck-boost converter, and a charge pump. The one or more external components coupled to the at least one follower charger can include at least one inductor or at least one capacitor. The DC-DC converter leader phase and the at least one DC-DC converter follower phase can be different converter types.

The at least one battery pack can be a single battery pack. The regulated leader output, and the regulated follower output can be coupled together and coupled to the single battery pack. The at least one battery pack can be a plurality of battery packs, and the regulated leader output and one or more regulated follower outputs are each respectively coupled to only one of the plurality of battery packs.

The at least one follower charger can include two follower chargers. The leader-follower communication interface can provide a demand signal from the leader charger to the one or more follower chargers.

A leader charger for use in a scalable battery charger system can include: an input that receives at least one leader input voltage; a DC-DC converter leader phase that receives the at least one input voltage and operates one or more switching devices of the DC-DC converter leader phase to generate a regulated leader output in cooperation with one or more external components coupled to the leader charger; leader control circuitry that operates the DC-DC converter leader phase to regulate the output; and a leader-follower communication interface that couples the leader control circuitry to at least one follower charger. The leader charger can further include: linear charging control circuitry adapted to control a charging transistor coupled between the leader output and at least one battery pack; and battery current sensing circuitry adapted to be coupled to at least one current sensor coupled in series with the at least one battery pack. The DC-DC converter leader phase is selected from the group consisting of: a buck converter, a boost converter, a buck-boost converter, and a charge pump. The leader-follower communication interface can be configured to provide a demand signal from the leader charger to one or more follower chargers.

A follower charger for use in a scalable battery charger system can include: an input that receives at least one follower input voltage; one or more DC-DC converter follower phases that receive the at least one follower input voltage and operates one or more switching devices of the DC-DC converter follower phases to generate a regulated output in cooperation with one or more external components coupled to the at least one follower charger; follower control circuitry that operates the one or more DC-DC converter follower phases to regulate the follower output; and a leader-follower communication interface that couples the follower control circuitry to a leader charger. The one or more DC-DC converter follower phases can be selected from the group consisting of: a buck converter, a boost converter, a buck-boost converter, and a charge pump. The leader-follower communication interface can be configured to receive a demand signal from a leader charger.

A scalable battery charger system can include: one or more charger modules. Each charger module can further include: control circuitry including outer control circuitry operable as a leader controller and inner control circuitry. The outer control circuitry can be selectively enabled to operate as a leader controller or selectively disabled or bypassed. The inner control circuitry can be operable as a follower controller under the direction of a leader controller, wherein the leader controller can be part of a same charger module of the one or more charger modules or a different charger module of the one or more charger modules. Each charger module can further include one or more switching devices operable by the control circuitry in cooperation with one or more external components to produce a regulated output and configurable with the one or more external components to operate as at least a buck converter or a boost converter. Multiple charger modules of the one or more charger modules can be combinable to provide one or more of increased output current and increased output voltage.

The scalable battery charger system described above can include a single charger module configured as a buck converter.

The scalable battery charger system described above can include two charger modules coupled together as a buck-boost converter, wherein a first charger module is configured as a buck stage, and a second charger module is configured as a boost stage. The two charger modules can be contained within a single package. The outer control circuitry of the second charger module can be disabled or bypassed, and the inner control circuitry of the second charger module can receive a demand signal from the outer control circuitry of the first charger module.

The scalable battery charger system described above can include two charger modules including a first charger module and a second charger module coupled together as a two-phase buck converter. The two charger modules can be contained within separate packages. The outer control circuitry of the second charger module can be disabled or bypassed, and the inner control circuitry of the second charger module can receive a demand signal from the outer control circuitry of the first charger module.

The scalable battery charger system described above can include four charger modules coupled together as a two-phase buck-boost converter, wherein first and second charger modules are coupled together as a first buck-boost converter phase and third and fourth charger modules are coupled together as a second buck-boost converter phase. The first and second buck-boost converter phases can be contained within separate packages. The outer control circuitry of the second, third, and fourth charger modules can be disabled or bypassed, and the inner control circuitry of the second, third, and fourth charger module can receive demand signals from the outer control circuitry of the first charger module. The control circuitry of each charger module can be contained on a respective single controller die. The one or more switching devices of each charger module can be contained on separate dies from the respective single controller dies.

### BRIEF DESCRIPTION OF THE DRAWINGS

FIG. 1 illustrates a block diagram of an electronic device.

FIG. 2 illustrates a plurality of electronic devices.

FIG. 3 illustrates a scalable battery charger architecture for an electronic device that can operate as a leader or as a stand-alone charger.

FIG. 4 illustrates a scalable battery charger architecture for an electronic device including a leader and a single follower charging a single battery.

FIG. 5 illustrates a scalable battery charger architecture for an electronic device including a leader and multiple followers charging a single battery.

FIG. 6 illustrates a scalable battery charger architecture for an electronic device including a leader charging a first battery and a follower charging a second battery separate from the first battery.

FIG. 7 is a plot depicting various scaling techniques and converter topologies for a scalable battery charger architecture as described herein.

FIG. 8 illustrates a relatively lower power buck converter based on a scalable battery charger architecture as described herein.

FIG. 9 illustrates a relatively higher power buck-boost converter based on a scalable battery charger architecture as described herein.

FIG. 10 illustrates a relatively higher power buck converter based on a scalable battery charger architecture as described herein.

FIG. 11 illustrates a relatively higher power buck-boost converter based on a scalable battery charger architecture as described herein.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a drawing, refers to the same element throughout the several drawings, though it may not be repeated in every drawing. The drawings are not to scale unless otherwise indicated, and the proportions of certain parts may be exaggerated to better illustrate details and features of the present disclosure.

### INTRODUCTION

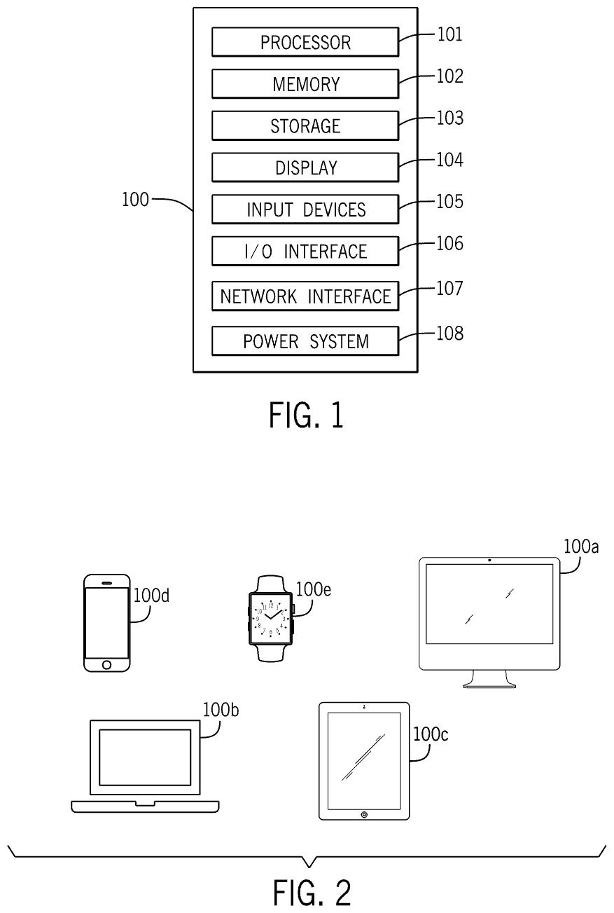

FIG. 1 is a block diagram of an electronic device 100, according to embodiments of the present disclosure. The electronic device 100 may include, among other things, one or more processors 101 (collectively referred to herein as a single processor for convenience, which may be implemented in any suitable form of processing circuitry), memory 102, nonvolatile storage 103, a display 104, input devices 105, an input/output (I/O) interface 106, a network interface 107, and a power system 108. The various functional blocks shown in FIG. 1 may include hardware elements (including circuitry), software elements (including machine-executable instructions), or a combination of both hardware and software elements (which may be referred to as logic). The processor 101, memory 102, the nonvolatile storage 103, the display 104, the input devices 105, the input/output (I/O) interface 106, the network interface 107, and/or the power system 108 may each be communicatively coupled directly or indirectly (e.g., through or via another component, a communication bus, a network, etc.) to one another to transmit and/or receive data amongst one another. It should be noted that FIG. 1 is merely one example of a particular implementation and is intended to illustrate the types of components that may be present in the electronic device 100.

By way of example, the electronic device 100 may include any suitable computing device, including a desktop or laptop/notebook computer (such as a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (such as an iPhone® available from Apple Inc. of Cupertino, California), a tablet computer (such as an iPad® available from Apple Inc. of Cupertino, California), a wearable electronic device (such as an Apple Watch® by Apple Inc. of Cupertino, California), and other similar devices.

Processor 101 and other related items in FIG. 1 may be embodied wholly hardware or by hardware programmed to execute suitable software instructions. Furthermore, the processor 101 and other related items in FIG. 1 may be a single contained processing module or may be incorporated wholly or partially within any of the other elements within the electronic device 100. Processor 101 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. Processor 101 may include one or more application processors, one or more baseband processors, or both, and perform the various functions described herein.

In the electronic device 100 of FIG. 1, processor 101 may be operably coupled with a memory 102 and a nonvolatile storage 103 to perform various algorithms. Such programs or instructions executed by processor 101 may be stored in any suitable article of manufacture that includes one or more tangible, computer-readable media. The tangible, computer-readable media may include the memory 102 and/or the nonvolatile storage 103, individually or collectively, to store the instructions or routines. The memory 102 and the nonvolatile storage 103 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by processor 101 to enable the electronic device 100 to provide various functionalities.

In certain embodiments, the display 104 may facilitate users to view images generated on the electronic device 100 In some embodiments, the display 104 may include a touch screen, which may facilitate user interaction with a user interface of the electronic device 100. Furthermore, it should be appreciated that, in some embodiments, the display 104 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input devices 105 of the electronic device 100 may enable a user to interact with the electronic device 100 (e.g., pressing a button to increase or decrease a volume level). The I/O interface 106 may enable electronic device 100 to interface with various other electronic devices, as may the network interface 107. In some embodiments, the I/O interface 106 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 107 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In particular, the network interface 107 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 107 of the electronic device 100 may allow communication over the aforementioned networks (e.g., 5G, Wi-Fi, LTE-LAA, and so forth).

The network interface 107 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

The power system 108 of the electronic device 100 may include any suitable source of power, such as a rechargeable battery (e.g., a lithium ion or lithium polymer (Li-poly) battery) and/or a power converter, including a DC/DC power converter, an AC/DC power converter, a power adapter (which may be external), etc. Power system 108 may include a scalable charger architecture as described in greater detail below.

FIG. 2 illustrates a plurality of electronic devices that can employ a scalable battery charger architecture as described herein. The illustrated electronic devices include a desktop computer 100a, a laptop computer 100b, a tablet computer 100c, a smartphone 100d, and a smartwatch 100c. The illustrated electronic devices are exemplary only, and other devices could also employ a scalable charger architecture as described herein. The illustrated electronic devices can include relatively lower power devices, such as smartphone 100d and/or smartwatch 100c. Other relatively lower power devices could include wireless headphones, styluses, various wearable devices, etc. The illustrated electronic devices can also include moderate power devices, such as a tablet computer 100c. The illustrated electronic devices can also include relatively higher power devices, such as laptop computer 100b or desktop computer 100a. The relatively lower power, moderate power, and relatively higher power examples given above are for context, and it is possible that such devices could fall into a different category based on the requirements of the device. For example, a smaller tablet might be a relatively lower power device. Laptop or notebook computers may be either moderate power or relatively higher power devices depending on the processing capabilities and other characteristics of the device. Likewise, a desktop computer might be a moderate power device or a relatively higher power device depending on the particular implementation, capabilities, etc. of the device. Thus, the above examples and further examples discussed herein should not be considered as limiting with respect to what constitutes a relatively lower, moderate, or relatively higher power device, but rather mere examples to provide context for the discussion herein.

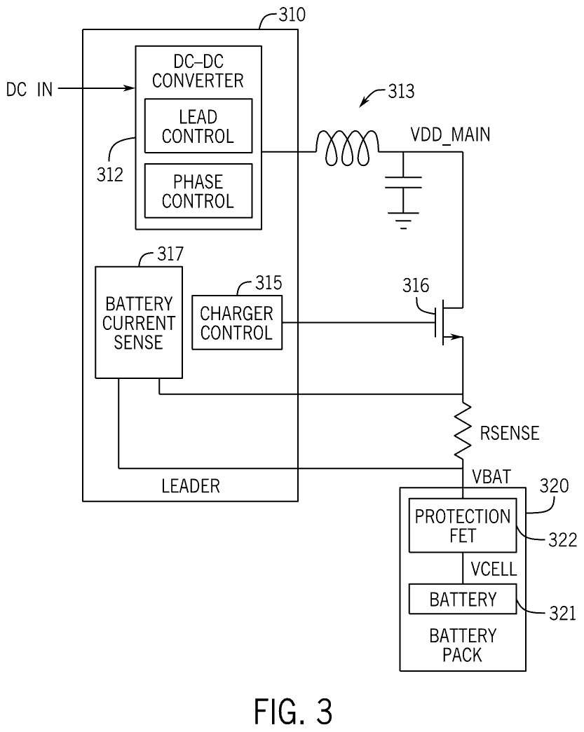

FIG. 3 illustrates a scalable battery charger architecture for an electronic device that can operate as a leader or as a stand-alone charger. The scalable battery charger architecture includes a leader charger 310 that can be operated to charge a battery back 320. Battery pack 320 can include a battery 321, which can include one or more cells. The cells can be of any suitable chemistry, such as lithium ion, lithium polymer, etc. Battery pack 320 may also include a protection FET (field effect transistor) 322 (also called a protection switch) that can operate to isolate the battery 321 if necessary for either over-charge or over-discharge protection. Implementation details of the battery pack 320 are not discussed in detail herein as the scalable battery architecture described herein can be configured or adapted to work with a wide variety of battery pack types, configurations, architectures, chemistries, etc.

Leader charger 310 can be implemented as one or more integrated circuit modules. For purposes of the description herein, leader charger 310 will be described as being implemented in a single integrated circuit (or chip), but multiple integrated circuit (multi-chip) implementations are also contemplated. In such multi-chip implementations, the separation and distribution of various components of the leader charger onto the various separate integrated circuits may be done to achieve any desired effect in terms of chip materials, process, functionality, etc. As illustrated, leader charger 310 can receive one or more DC bus voltages (DC In). These one or more input voltages can be received from a suitable source, such as a power supply that is internal or external to the electronic device. In some cases, the power supply may power the device from a DC source. In other cases, the power supply may power the device from an AC source, in which case the power supply may include AC/DC rectifier circuitry. In either case, the power supply may include other conversion, regulation, or conditioning circuitry as appropriate for a given application.

DC-DC converter leader phase 312 can be any suitable DC-DC power converter topology that can be used to generate a bus voltage VDD_MAIN that can be used both to provide a power source for battery charging and to power the electronic device in which the scalable charger is placed. The DC-DC converter leader phase can be implemented using any suitable switching converter architecture, including buck, boost, buck-boost and other converter types, charge pumps, and the like. To that end, the DC-DC converter leader phase may include various configurations of switching devices and their associated drive circuitry, as well as one or more control loops that can implement voltage or current based control of the output. These control loops may include a master or leader control loop as well as one or more phase control loops. The components of the DC-DC converter leader phase 312 can cooperate with external components 313 to provide the bus voltage VDD_MAIN. For example, external components such as inductors and/or capacitors may be provided, which can be driven by the switching devices that are part of DC-DC converter leader phase 312 to produce the bus voltage VDD_MAIN. Values and configuration of external components 313 may be selected as desired to provide the desired output current, voltage, and other characteristics, such as frequency response, impedance, etc.

Also included in leader charger 310 is linear battery charger control circuitry 315. This linear battery charger control circuitry can cooperate to control a charging FET (field effect transistor) 316, which can be used to regulate the charging current provided to battery pack 320. The linear battery charger control circuitry can be responsive to battery charging logic (not shown), which can provide a target battery charging current or target battery charging voltage based on a particular battery charging program that can account for battery voltage, temperature, state of charge, aging, and other parameters. Various battery charging algorithms and profiles are known in the art, and thus their details are not reproduced here. The scalable charger system described herein can be used with any such battery charging algorithms and profiles, including later-developed battery charging algorithms and profiles. In addition to regulating charging current, the linear battery control circuitry can also implement “active diode” functionality, which allows charging control FET to be turned on when the battery is not charging (i.e., discharging) to allow for lower voltage drop across the charging FET 316 and therefore increased operating efficiency. Leader charger 310 can also include battery current sensing circuitry 317. Battery current sensing circuitry 317 can cooperate with an external current sensor Rsense to monitor the battery current. The external current sensor can be a current sense resistor (as shown) or can be another suitable current sensor, such as a Hall effect sensor or other suitable current sensing device.

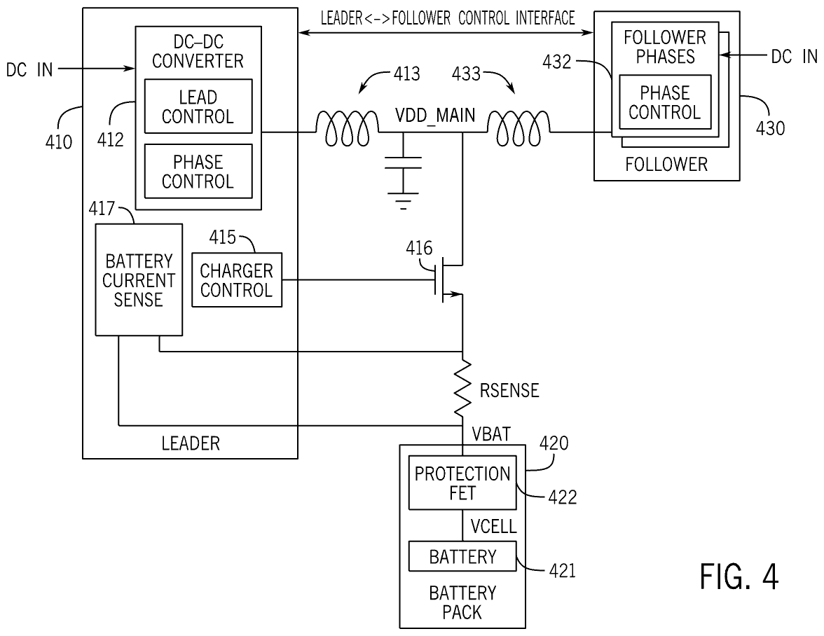

FIG. 4 illustrates a scalable battery charger architecture for an electronic device including a leader charger 410 and a single follower charger 430 charging a single battery pack 420. Leader charger 410 can be as described above with respect to leader charger 310, with 300-series reference numerals being replaced by 400-series reference numerals. Likewise, battery pack 420 can be as described above with respect to battery pack 320, with 300-series reference numerals being replaced by 400-series reference numerals. That said, leader charger 410 can be different from leader charger 310 in one or more respects, depending on the implementation. Similarly, battery pack 420 can be different from battery pack 320 in one or more respects, depending on the implementation. For example, battery pack 420 may have a higher capacity than battery pack 320 and/or may have a different number or configuration of cells in battery 421, etc. Nonetheless, for understanding of the scalable battery charger architecture described herein, leader charger 410 and battery pack 420 may be thought of as being generally the same as corresponding leader charger 310 and battery pack 320.

One potential advantage of the scalable battery charger architecture described herein is the addition of one or more follower battery chargers 430 to provide increased charging capacity. For example, the same leader charger 310/410 can be used in a low power application with a lower capacity battery pack 320, as depicted in FIG. 3 and in a higher power application with a higher capacity battery pack 420 as depicted in FIG. 4. To provide for increased charging current, a follower charger 430 can be provided. Follower charger 430 can be a simplified circuit including one or more follower phases 432 that receive a DC input voltage as discussed above. The follower phases 432 can be any suitable power converter/regulator technology, such as buck, boost, buck-boost and other converter types, charge pumps, and the like. The converter types used for follower phases 432 can but need not be the same converter types used for DC-DC converter leader phases 412. In any case, the follower phases may include various configurations of switching devices and their associated drive circuitry, as well as one or more control loops that can implement voltage or current based control of the output. As described in greater detail below, the control loops for the follower phases can be simplified control loops that receive a control command from the leader charger 410. The components of the follower phases 432 can cooperate with external components 433 to provide the bus voltage VDD_MAIN in tandem with the leader charger 410, providing increased current capacity for charging battery pack 420. For example, external components such as inductors and/or capacitors may be provided, which can be driven by the switching devices that are part of follower phase(s) 432 to produce the bus voltage VDD_MAIN. Values and configuration of external components 433 may be selected as desired to provide the desired output current, voltage, and other characteristics, such as frequency response, impedance, etc.

As noted above, the controller portions of follower charger 430 can be simplified as compared to the controller portions of leader charger 410. More specifically, leader charger 410 can implement the overall control logic for voltage regulation, current regulation, and other aspects, such as battery charging profile, etc. The leader charger can provide a demand signal via the Leader<->Follower Control Interface, and the phase control circuitry in follower charger 430 can respond to this demand signal to provide the desired output. For example, the demand signal can be a voltage demand signal in which leader charger 410 uses its own control logic to determine an appropriate output voltage for follower charger 430, and the phase control circuitry can respond to the voltage demand signal to regulate the output voltage of follower charger 430. Similarly, the demand signal can be a current demand signal in which leader charger 410 uses its own control logic to determine an appropriate output current for follower charger 430, and the phase control circuitry of follower charger 430 can respond to the current demand signal to regulate the output current of follower charger 430.

In addition to the demand signals described above, the Leader<->Follower Control Interface can provide for other communication between leader charger 410 and follower charger 430. This other communication can include sensed parameters within follower charger 430, such as voltages, currents, temperatures, etc. The sensed and communicated parameters can be used by the control circuitry in leader charger 410 to provide protection (e.g., overvoltage, overcurrent, or overtemperature protection). The sensed and communicated parameters can be used by the control circuitry in leader charger 410 for other purposes, such as control loop tuning, etc. The communications between leader charger 410 and follower charger 430 over the Leader<->Follower Control Interface can be implemented using analog or digital signals using a suitable number of conductors or bus width. In some cases, digital communication protocols such as serial peripheral interface (SPI) or inter-integrated circuit (I2C) communication may be used. The aforementioned examples are not intended to be limiting, as any suitable one-way or two-way communication between leader charger 410 and follower charger 430 could be provided depending on the requirements of the application or implementation.

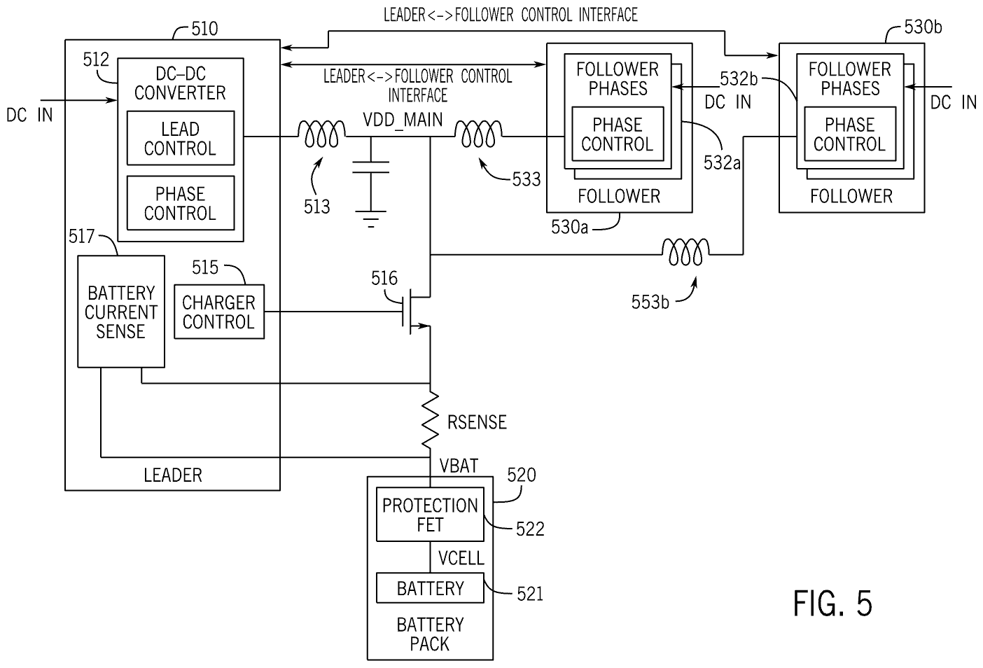

FIG. 5 illustrates a scalable battery charger architecture for an electronic device including a leader charger 510 and multiple follower chargers 532a, 532b charging a single battery pack 520. Leader charger 510 can be as described above with respect to leader chargers 310, 410, with 300- or 400-series reference numerals being replaced by 500-series reference numerals. Likewise, battery pack 520 can be as described above with respect to battery packs 320, 420, with 300- or 400-series reference numerals being replaced by 500-series reference numerals. That said, leader charger 510 can be different from leader chargers 310 or 410 in one or more respects, depending on the implementation. Similarly, battery pack 520 can be different from battery packs 320 or 420 in one or more respects, depending on the implementation. For example, battery pack 520 may have a higher capacity than battery packs 320 or 420 and/or may have a different number or configuration of cells in battery 521, etc. Nonetheless, for understanding of the scalable battery charger architecture described herein, leader charger 510 and battery pack 520 may be thought of as being generally the same as corresponding leader chargers 310, 410 and battery packs 320, 420 as discussed above.

As discussed above, one potential advantage of the scalable battery charger architecture described herein is the addition of additional follower battery chargers 530a, 530b to provide increased charging capacity. For example, the same leader charger 310/410/510 can be used in a low power application with a lower capacity battery pack 320, as depicted in FIG. 3, in a higher (mid) power application with a higher capacity battery pack 420 as depicted in FIG. 4, and in a still higher (high) power application with an even higher capacity battery pack 520 as depicted in FIG. 5. As but one example, a low power application could include a relatively low power device such as a smartphone. A mid power device could include a device with slightly higher power requirements, such as a tablet computer. A high power device could include a device with even higher power requirements, such as a notebook or desktop computer. These examples are illustrative, and other device types or devices of the same type having different power requirements (low/mid/high) could also be used.

In any case, to provide for increased charging current, multiple follower chargers 530a, 530b can be provided. Follower chargers 530a, 530b can be simplified circuits including one or more follower phases 532a, 532b that receive a DC input voltage DC in as discussed above. The follower phases 532a, 532b can be any suitable power converter/regulator technology, such as buck, boost, buck-boost and other converter types, charge pumps, and the like. The converter types used for follower phases 532a, 532b can but need not be the same converter types used for DC-DC converter leader phases 512. Likewise, the converter types used for follower phases 532a, 532b can but need not be the same as each other, i.e., follower phases 532a could be a different type of converter than follower phases 532b. In any case, the follower phases may include various configurations of switching devices and their associated drive circuitry, as well as one or more control loops that can implement voltage or current based control of the output. As described in greater detail below, the control loops for the follower phases can be simplified control loops that receive a control command from the leader charger 510. The components of the follower phases 532a, 532b can cooperate with external components 533a, 533b, respectively to provide the bus voltage VDD_MAIN in tandem with the leader charger 510, providing increased current capacity for charging battery pack 520. For example, external components such as inductors and/or capacitors may be provided, which can be driven by the switching devices that are part of follower phase(s) 532a, 532b to produce the bus voltage VDD_MAIN. Values and configuration of external components 533a, 533b may be selected as desired to provide the desired output current, voltage, and other characteristics, such as frequency response, impedance, etc.

As noted above the controller portions of follower chargers 530a, 530b can be simplified as compared to the controller portions of leader charger 510. More specifically, leader charger 510 can implement the overall control logic for voltage regulation, current regulation, and other aspects, such as battery charging profile, etc. The leader charger can provide demand signals to the follower chargers 530a, 530b via respective Leader<->Follower Control Interfaces, and the phase control circuitry in follower chargers 530a, 530b can respond to these demand signals to provide the desired output. For example, the demand signals can be voltage demand signals in which leader charger 510 uses its own control logic to determine an appropriate output voltage for follower chargers 530a, 530b, and the phase control circuitry can respond to the voltage demand signals to regulate the output voltages of follower chargers 530a, 530b. Similarly, the demand signals can be current demand signals in which leader charger 510 uses its own control logic to determine an appropriate output current for follower chargers 530a, 530b, and the phase control circuitry of follower chargers 530, 530b can respond to the current demand signals to regulate the output currents of follower chargers 530a, 530b.

In addition to the demand signals described above, the Leader<->Follower Control Interface can provide for other communication between leader charger 510 and follower chargers 530a, 530b. This other communication can include sensed parameters within follower charger 530a, 530b, such as voltages, currents, temperatures, etc. The sensed and communicated parameters can be used by the control circuitry in leader charger 510 to provide protection (e.g., overvoltage, overcurrent, or overtemperature protection). The sensed and communicated parameters can be used by the control circuitry in leader charger 510 for other purposes, such as control loop tuning, etc. The communications between leader charger 510 and follower chargers 530a, 530b over the Leader<->Follower Control Interface can be implemented using analog or digital signals using a suitable number of conductors or bus width. In some cases, digital communication protocols such as serial peripheral interface (SPI) or inter-integrated circuit (I2C) communication may be used. The aforementioned examples are not intended to be limiting, as any suitable one-way or two-way communication between leader charger 510 and follower chargers 530a, 530b could be provided depending on the requirements of the application or implementation.

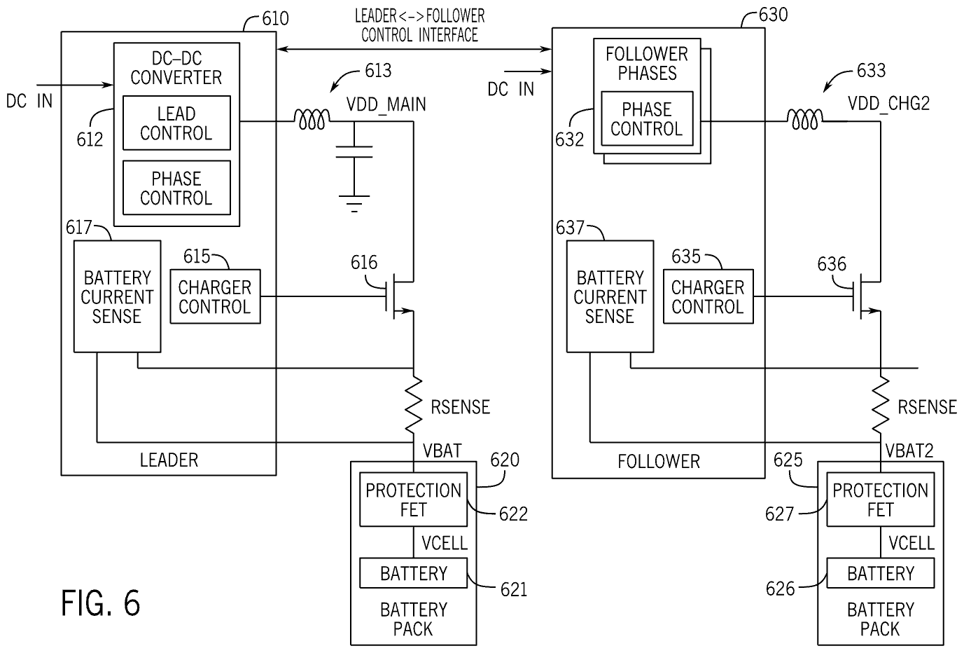

FIG. 6 illustrates a scalable battery charger architecture for an electronic device including a leader charger 610 charging a first battery 620 and a follower charger 630 charging a second battery 625 separate from the first battery. Leader charger 610 can be as described above with respect to leader chargers 310, 410, and 510, with 300-series, 400-series, or 500-series reference numerals being replaced by 600-series reference numerals. Likewise, battery pack 620 can be as described above with respect to battery packs 320, 420, and 520 with 300-series, 400-series, and 500-series reference numerals being replaced by 600-series reference numerals. Also, additional battery pack 625 can correspond to battery pack 620, although it may have a higher voltage, higher capacity, different chemistry, different number or configuration of cells 626, different protection circuitry 627, etc. That said, leader charger 610 can be different from leader chargers 310, 410, 510 in one or more respects, depending on the implementation. Similarly, battery packs 620 and 625 can be different from battery packs 320, 420, 520 in one or more respects (as described above), depending on the implementation. Nonetheless, for understanding of the scalable battery charger architecture described herein, leader charger 610 and battery packs 620, 625 may be thought of as being generally the same as corresponding leader chargers 310, 410, 510 and battery packs 320, 420, 520 discussed above.

Another potential advantage of the scalable battery charger architecture described herein is the addition of one or more follower battery chargers 630 to provide charging of additional/separate battery packs, e.g., battery pack 625. As in the above-described embodiments, follower charger 630 can be a simplified circuit including one or more follower phases 632 that receive the conditioned input voltage VMID as discussed above. The follower phases 632 can be any suitable power converter/regulator technology, such as buck, boost, buck-boost and other converter types, charge pumps, and the like. The converter types used for follower phases 632 can but need not be the same converter types used for DC-DC converter leader phases 612. In any case, the follower phases may include various configurations of switching devices and their associated drive circuitry, as well as one or more control loops that can implement voltage or current based control of the output. As described in greater detail below, the control loops for the follower phases can be simplified control loops that receive a control command from the leader charger 610. The components of the follower phases 632 can cooperate with external components 633 to provide the bus voltage VDD_CHG2, providing a separate charging path for charging battery pack 625. For example, external components such as inductors and/or capacitors may be provided, which can be driven by the switching devices that are part of follower phase(s) 632 to produce the bus voltage VDD_CHG2. Values and configuration of external components 633 may be selected as desired to provide the desired output current, voltage, and other characteristics, such as frequency response, impedance, etc.

As noted above, the controller portions of follower charger 630 can be simplified as compared to the controller portions of leader charger 610. More specifically, leader charger 610 can implement the overall control logic for voltage regulation, current regulation, and other aspects, such as battery charging profile, etc. The leader charger can provide a demand signal via the Leader<->Follower Control Interface, and the phase control circuitry in follower charger 630 can respond to this demand signal to provide the desired output. For example, the demand signal can be a voltage demand signal in which leader charger 610 uses its own control logic to determine an appropriate output voltage for follower charger 630, and the phase control circuitry can respond to the voltage demand signal to regulate the output voltage of follower charger 630. Similarly, the demand signal can be a current demand signal in which leader charger 610 uses its own control logic to determine an appropriate output current for follower charger 630, and the phase control circuitry of follower charger 630 can respond to the current demand signal to regulate the output current of follower charger 630.

In addition to the demand signals described above, the Leader<->Follower Control Interface can provide for other communication between leader charger 610 and follower charger 630. This other communication can include sensed parameters within follower charger 630, such as voltages, currents, temperatures, etc. The sensed and communicated parameters can be used by the control circuitry in leader charger 610 to provide protection (e.g., overvoltage, overcurrent, or overtemperature protection). The sensed and communicated parameters can be used by the control circuitry in leader charger 610 for other purposes, such as control loop tuning, etc. Additionally, in the configuration shown in FIG. 6, the follower charger 630 may monitor the charging current (via current sensor Rsense) supplied to battery pack 625 and provide this information to leader charger 610, which can implement the battery charging profile and control loop for both battery packs. The communications between leader charger 610 and follower charger 630 over the Leader<->Follower Control Interface can be implemented using analog or digital signals using a suitable number of conductors or bus width. In some cases, digital communication protocols such as serial peripheral interface (SPI) or inter-integrated circuit (I2C) communication may be used. The aforementioned examples are not intended to be limiting, as any suitable one-way or two-way communication between leader charger 610 and follower charger 630 could be provided depending on the requirements of the application or implementation.

Feedback for battery charging control can include sensing of battery parameters such as current, voltage, temperature, etc. by follower charger 630 (as depicted in FIG. 6). In this case, the sensed battery parameters may be communicated from follower charger 630 to leader charger 610 via the Leader<->Follower Control interface, and the battery charging control logic/circuitry in leader charger 610 can compute and deliver the appropriate voltage and/or current control signals to follower charger 630 via the same interface. Alternatively, the second battery pack 625 could have its various sensor outputs coupled to leader charger 610 directly (not shown in FIG. 6), with the control signals for follower charger 630 being again provided by leader charger 610 over the Leader<->Follower Control interface.

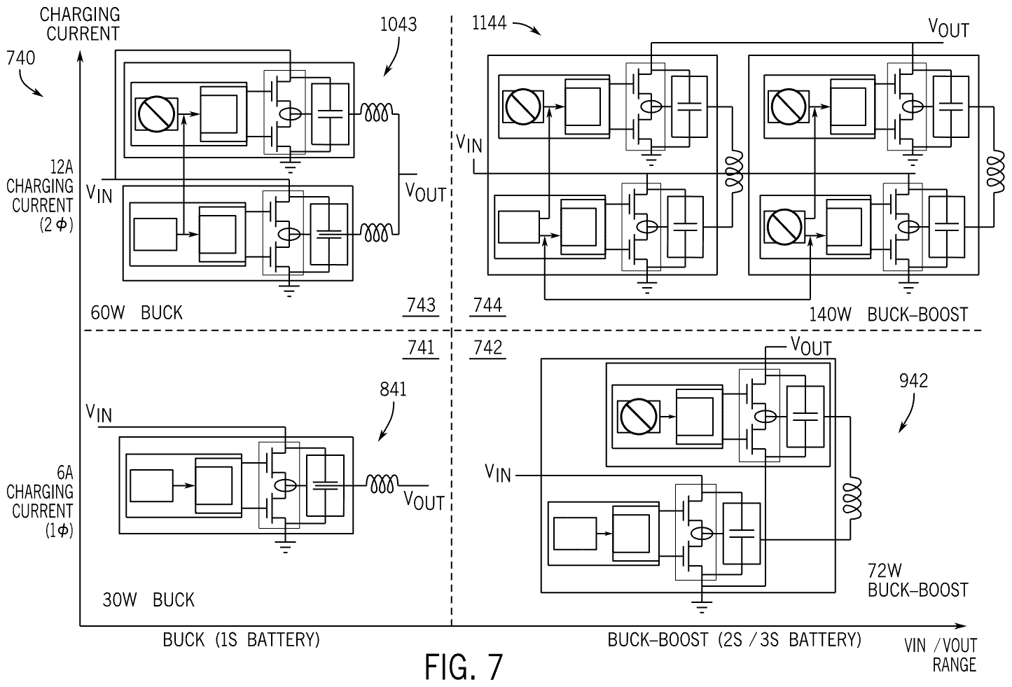

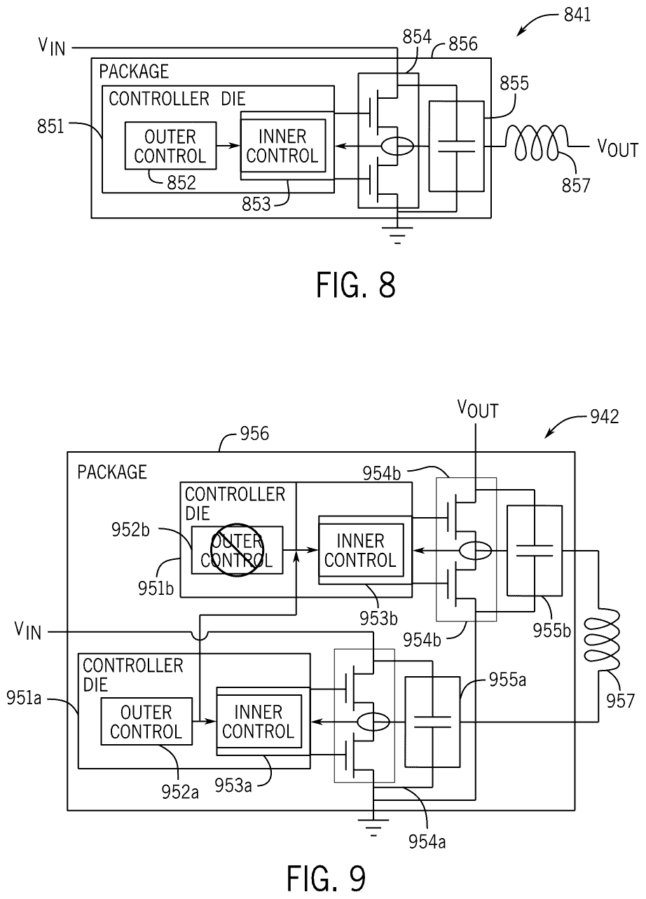

FIG. 7 is a plot 740 depicting various scaling techniques and converter topologies for a scalable battery charger architecture as described herein. The horizontal axis of the plot indicates scaling of output voltage, and the vertical axis of the plot indicates scaling of output current. Lower left quadrant 741 depicts a single leader converter 841 described in greater detail below with respect to FIG. 8. As but one non-limiting example, leader converter 841 could be a buck converter for use in charging batteries having a single series cell (although such batteries could have multiple cells connected in parallel to provide greater current/power capabilities). For example, the converter could have an output voltage of up to 5V and an output (charging) current of 6 A, for a total capacity of 30 W. These values are merely provided as relative indicators of scale, and the actual leader converter 841 could be designed with any desired voltage, current, and power capacity.

Lower right quadrant 742 depicts a leader/follower converter 942 described in greater detail below with respect to FIG. 9. As but one non-limiting example, leader/follower converter 942 could be scaled “out” as a buck-boost converter for use in charging batteries having a two-series or three-series cell configuration. As above, such batteries could have multiple cell strings connected in parallel to provide greater current/power capabilities. For example, the converter could have an output voltage of up to 12V and an output (charging) current of 6 A, for a total capacity of 72 W. As above, values are merely provided as relative indicators of scale, and the actual leader/follower converter 942 could be designed with any desired voltage, current, and power capacity.

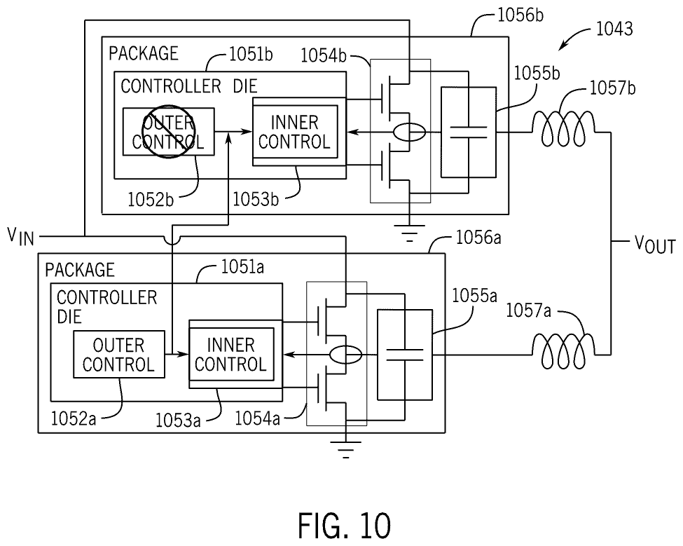

Upper left quadrant 743 depicts a leader/follower converter 1043 described in greater detail below with respect to FIG. 10. As but one non-limiting example, leader/follower converter 1043 could be scaled “up” as a buck converter for use in charging batteries having a one-series cell configuration. As above, such batteries could have multiple cell strings connected in parallel to provide greater current/power capabilities, and, in fact, the upscaling of charging current could be selected to provide for better charging performance for such batteries. As one example, the converter could have an output voltage of up to 5V (as in the case of leader converter 841) and an output (charging) current of 12 A (from two paralleled phases), for a total capacity of 60 W. Again, these values are merely provided as relative indicators of scale, and the actual leader/follower converter 1043 could be designed with any desired voltage, current, and power capacity.

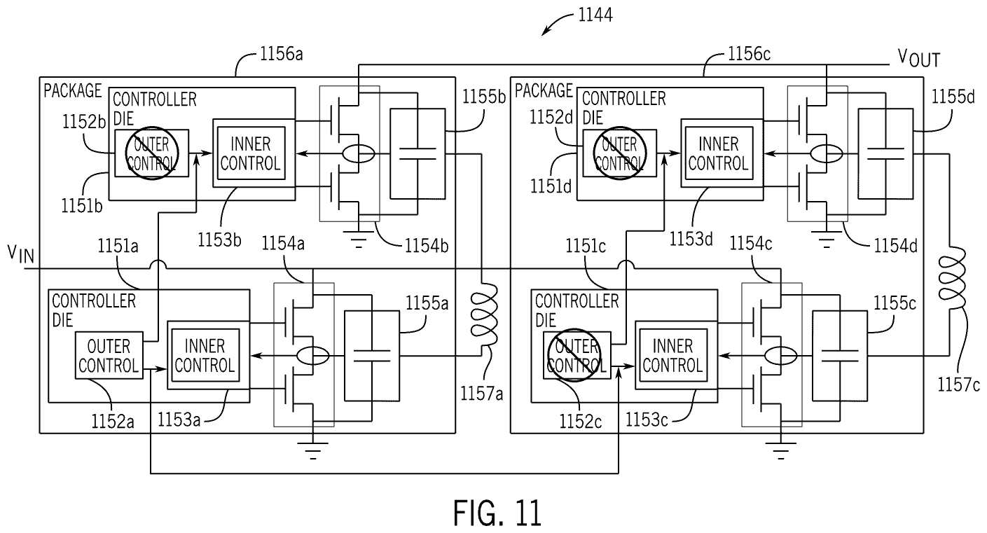

Upper right quadrant 744 depicts a leader/follower converter 1144 described in greater detail below with respect to FIG. 11. As but one non-limiting example, leader/follower converter 1144 could be scaled “up” and “out” as a buck-boost converter for use in charging batteries having a two-series or three-series cell configuration. As above, such batteries could have multiple cell strings connected in parallel to provide greater current/power capabilities, and the increased current capabilities as compared to leader/follower converter 942 may be advantageous in charging such battery configurations. As an example, the converter could have an output voltage of up to about 12V (as in the case of leader/follower converter 942) and an output (charging) current of 12 A (from two paralleled phases), for a total capacity of about 140 W. As above, values are merely provided as relative indicators of scale, and the actual leader/follower converter 1144 could be designed with any desired voltage, current, and power capacity.

FIG. 8 illustrates a leader converter 841 in the form of a relatively lower power buck converter based on a scalable battery charger architecture as described herein. Leader converter 841 can include a controller die 851, switching circuitry 854, and capacitor(s) 855 disposed within an integrated circuit package 856. This configuration is but one example. Other configurations are possible, such as a configuration in which switching devices 854 are external devices that interface with controller die 851 contained within package 856. Still another configuration would be for switching devices 854 and/or capacitors 855 to also reside on the controller die 851, although this may not be advantageous in all situations due to different process node characteristics in terms of feature size, current and voltage ratings, etc.

In any case, controller die 851 can include multiple controller circuitries, such as outer control circuitry 852 and inner control circuitry 853. These controllers can be configured to provide the desired functionality. For example, outer control circuitry 852 can include the overall voltage and/or current regulation logic for the converter, and inner control circuitry 853 can include the particular duty cycle control and driver circuitry for switching circuitry 854. In other embodiments, outer control circuitry 852 can implement an outer control loop, such as a voltage control loop, and inner control circuitry 853 can implement an inner control loop, such as a current control loop or vice-versa. Regardless of the exact implementation of the respective controller circuitry, for purposes of the following discussions of scalability of leader converter 841, outer control circuitry 852 may be thought of as the “leader” controller, with inner control circuitry 853 receiving a demand signal from the outer control circuitry 852 and controlling the switching devices 854 responsive to such demand signal. The switching devices may then cooperate with external components, such as inductor 857 to generate a regulated output voltage Vout from the input voltage Vin. In the illustrated configuration, the switching circuitry is connected so that a buck converter is formed, although other configurations are also possible depending on the particular switching device and energy storage device configurations.

FIG. 9 illustrates a leader/follower converter 942 in the form of a relatively higher power buck-boost converter based on a scalable battery charger architecture as described herein. The leader converter portion of leader/follower converter 942 can include a first controller die 951a, first switching circuitry 954a, and first capacitor(s) 955a disposed within an integrated circuit package 956. The follower converter portion of leader follower converter 942 can include a second controller die 951b, second switching circuitry 954b, and second capacitor(s) 955b also disposed within the integrated circuit package 956. This configuration is but one example, illustrating the “scale out” configuration described above with respect to FIG. 7. As with leader converter 841 discussed above with respect to FIG. 8, other packaging configurations are also possible, such as a configuration in which switching devices 954a, 954b are external devices that interface with controller dies 951a, 951b contained within package 956. Still another configuration would be for switching devices 954a, 954b and/or capacitors 955a, 955b to also reside on respective controller dies 951a, 951b, although this may not be advantageous in all situations due to different process node characteristics in terms of feature size, current and voltage ratings, etc.

In any case, controller dies 951a, 951b can each include multiple controller circuitries, such as outer control circuitry 952a, 952b and inner control circuitry 953a, 953b. These controllers can be configured to provide the desired functionality as was described above. For purposes of the discussions herein, outer control circuitry 952a may be thought of as the “leader” controller, with inner control circuitry 953a receiving a demand signal from the outer control circuitry 952a and controlling the switching devices 954a responsive to such demand signal. Similarly, inner control circuitry 953b can also receive a demand signal from outer control circuitry 952a, allowing switching stage 954b to act as a follower. This can also allow outer control circuitry 952b to be bypassed or disabled. The switching devices 954a, 954b (under control of their respective inner controllers 953a, 953b and the leader outer controller 952a) may then cooperate with external components, such as inductor 957 to generate a regulated output voltage Vout from the input voltage Vin. In the illustrated configuration, the switching circuitry is connected so that a buck-boost converter is formed, although other configurations are also possible depending on the particular switching device and energy storage device configurations.

FIG. 10 illustrates a leader/follower converter 1043 in the form of a relatively higher power buck converter based on a scalable battery charger architecture as described herein. The leader converter portion of leader/follower converter 1043 can include a first controller die 1051a, first switching circuitry 1054a, and first capacitor(s) 1055a disposed within an integrated circuit package 1056a. The follower converter portion of leader/follower converter 1043 can include a second controller die 1051b, second switching circuitry 1054b, and second capacitor(s) 1055b disposed within a second integrated circuit package 1056b. This configuration is but one example, illustrating the “scale up” configuration described above with respect to FIG. 7. As with leader converter 841 discussed above with respect to FIG. 8, other packaging configurations are also possible, such as a configuration in which switching devices 1054a, 1054b are external devices that interface with controller dies 1051a, 1051b contained within packages 1056a, 1056b. Still another configuration would be for switching devices 1054a, 1054b and/or capacitors 1055a, 1055b to also reside on respective controller dies 1051a, 1051b, although this may not be advantageous in all situations due to different process node characteristics in terms of feature size, current and voltage ratings, etc. Yet another configuration would be for all of the leader and follower circuitry to be incorporated into a single package.

In any case, controller dies 1051a, 1051b can each include multiple controller circuitries, such as outer control circuitry 1052a, 1052b and inner control circuitry 1053a, 1053b. These controllers can be configured to provide the desired functionality as was described above. For purposes of the discussions herein, outer control circuitry 1052a may be thought of as the “leader” controller, with inner control circuitry 1053a receiving a demand signal from the outer control circuitry 1052a and controlling the switching devices 1054a responsive to such demand signal. Similarly, inner control circuitry 1053b can also receive a demand signal from outer control circuitry 1052a, allowing switching stage 1054b to act as a follower. This can also allow outer control circuitry 1052b to be bypassed or disabled. The switching devices 1054a, 1054b (under control of their respective inner controllers 1053a, 1053b and the leader outer controller 1052a) may then cooperate with external components, such as inductors 1057a, 1057b to generate a regulated output voltage Vout from the input voltage Vin. In the illustrated configuration, the switching circuitry is connected so that a two-phase buck converter is formed, although other configurations are also possible depending on the particular switching device and energy storage device configurations.

FIG. 11 illustrates leader/follower converter 1144 in the form of a relatively higher power two-phase buck-boost converter based on a scalable battery charger architecture as described herein. The leader converter portion of leader/follower converter 1144 can include a first controller die 1151a, first switching circuitry 1154a, and first capacitor(s) 1155a disposed within an integrated circuit package 1156a. A first follower converter portion of leader/follower converter 1144 can include a second controller die 1151b, second switching circuitry 1154b, and second capacitor(s) 1155b also disposed within the integrated circuit package 1156a. This first portion of leader/follower converter 1144 is a first buck-boost converter phase similar to that described above with respect to FIG. 9. A third follower portion can include a corresponding second phase of the buck boost converter. The second phase can include a third controller die 1151c, third switching circuitry 1154c, and third capacitor(s) 1155c disposed within an integrated circuit package 1156c. A fourth follower converter portion of leader/follower converter 1144 can include a fourth controller die 1151d, fourth switching circuitry 1154d, and fourth capacitor(s) 1155d also disposed within the integrated circuit package 1156c. The foregoing configuration is but one example, illustrating the “scale up and scale out” configuration described above with respect to FIG. 7. As with leader converter 841 discussed above with respect to FIG. 8, other packaging configurations are also possible, such as a configuration in which switching devices 1154a, 1154b, 1154c, 1154d are external devices that interface with controller dies 1151a, 1151b, 1151c, 1151d contained within packages 1156a, 1156c. Still another configuration would be for switching devices 1154a, 1154b, 1154c, 1154d and/or capacitors 1155a, 1155b, 1155c, 1155d to also reside on respective controller dies 1151a, 1151b, 1151c, 1151d although this may not be advantageous in all situations due to different process node characteristics in terms of feature size, current and voltage ratings, etc. Yet another configuration would be for all of the leader and follower circuitry to be incorporated into a single package. These packaging configurations are merely exemplary, and other permutation are also possible.

In any case, controller dies 1151a, 1151b, 1151c, 1151d can each include multiple controller circuitries, such as outer control circuitry 1152a, 1152b, 1152c, 1152d and inner control circuitry 1153a, 1153b, 1153c, 1153d. These controllers can be configured to provide the desired functionality as was described above. For purposes of the discussions herein, outer control circuitry 1152a may be thought of as the “leader” controller, with inner control circuitry 1153a receiving a demand signal from the outer control circuitry 1152a and controlling the switching devices 1154a responsive to such demand signal. Similarly, inner control circuitry 1153b, 1153c, 1153d can also receive demand signals from outer control circuitry 1152a, allowing switching stages 1154b, 1154c, 1154d to act as followers. This can also allow outer control circuitry 1152b, 1152c, 1152d to be bypassed or disabled. The switching devices 1154a, 1154b, 1154c, 1154d (under control of their respective inner controllers 1153a, 1153b, 1153c, 1153d and the leader outer controller 1152a) may then cooperate with external components, such as inductors 1157a, 1157c to generate a regulated output voltage Vout from the input voltage Vin. In the illustrated configuration, the switching circuitry is connected so that a two-phase buck-boost converter is formed, although other configurations are also possible depending on the particular switching device and energy storage device configurations.

Various aspects of a scalable battery charger architecture are described above. The scalable battery charger architecture can leverage the concept of a leader charger including a DC-DC converter with multi loop control (ICHG, IBUS, VBUS, VBAT) able to drive follower DC-DC power phases. This architecture can provide a single control and interface in the leader phase while allowing several degrees of scalability across platforms. Such scalability can include scaling power across different platforms, providing a baseline charge current capability for a low power platform and being easily extensible to medium and high power platform by adding extra follower phases as needed. Such scalability can also include supporting multiple-battery systems with centralized leader multi-loop charge control and additional follower phases per battery. In other configurations the scalability can also include supporting multiple-adapter systems with centralized leader multi-loop charge control and separate follower phases per each power input.

In some applications, further advantages of this scalable charger architecture can include minimizing the number of redesigns needed for example to: (1) supply higher input voltages or (2) incorporate technology improvements to achieve better performance. In either case, such adaptation could be accomplished by redesigning the follower phases only, driving most of the power delivery, while leaving the leader phase and main control loop unchanged. Additionally, in at least some embodiments, implementation of such scalable battery charger architectures can provide flexibility in distributing the thermal load, avoiding hot spots and premature charge current throttling.

The foregoing describes exemplary embodiments of a scalable battery charger architecture. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A scalable battery charger system comprising:
a leader charger, the leader charger further comprising:
an input that receives at least one leader input voltage;
a DC-DC converter leader phase that receives the at least one input voltage and operates one or more switching devices of the DC-DC converter leader phase to generate a regulated leader output in cooperation with one or more external components coupled to the leader charger;
leader control circuitry that operates the DC-DC converter leader phase to regulate the output; and
a leader-follower communication interface that couples the leader control circuitry to at least one follower charger;
at least one follower charger, the follower charger further comprising:
an input that receives at least one follower input voltage;
one or more DC-DC converter follower phases that receive the at least one follower input voltage and operates one or more switching devices of the DC-DC converter follower phases to generate a regulated output in cooperation with one or more external components coupled to the at least one follower charger;
follower control circuitry that operates the one or more DC-DC converter follower phases to regulate the follower output; and
a leader-follower communication interface that couples the follower control circuitry to the leader charger;
at least one battery pack, the at least one battery pack further comprising:
a battery having one or more cells; and
a protection switch.

2. The scalable battery charger system of claim 1 wherein the leader charger further comprises:
linear charging control circuitry that controls a charging transistor coupled between the leader output and the at least one battery pack; and
battery current sensing circuitry coupled to at least one current sensor coupled in series with the at least one battery pack.

3. The scalable battery charger system of claim 1 wherein:
the DC-DC converter leader phase is selected from the group consisting of: a buck converter, a boost converter, a buck-boost converter, and a charge pump;
the one or more external components coupled to the leader charger include at least one inductor or at least one capacitor;
the at least one DC-DC converter follower phase is selected from the group consisting of: a buck converter, a boost converter, a buck-boost converter, and a charge pump; and
the one or more external components coupled to the at least one follower charger include at least one inductor or at least one capacitor.

4. The scalable battery charger system of claim 3 wherein the DC-DC converter leader phase and the at least one DC-DC converter follower phase are different converter types.

5. The scalable battery charger system of claim 1 wherein:
the at least one battery pack is a single battery pack; and
the regulated leader output and the regulated follower output are coupled together and coupled to the single battery pack.

6. The scalable battery charger system of claim 1 wherein:
the at least one battery pack is a plurality of battery packs;
the regulated leader output and one or more regulated follower outputs are each respectively coupled to only one of the plurality of battery packs.

7. The scalable battery charger system of claim 1 wherein the at least one follower charger comprises two follower chargers.

8. The scalable battery charger system of claim 1 wherein the leader-follower communication interface provides a demand signal from the leader charger to the one or more follower chargers.

9. A leader charger for use in a scalable battery charger system, the leader charger comprising:
an input that receives at least one leader input voltage;
a DC-DC converter leader phase that receives the at least one input voltage and operates one or more switching devices of the DC-DC converter leader phase to generate a regulated leader output in cooperation with one or more external components coupled to the leader charger;
leader control circuitry that operates the DC-DC converter leader phase to regulate the output; and
a leader-follower communication interface that couples the leader control circuitry to at least one follower charger.

10. The leader charger for use in a scalable battery charger system of claim 9 wherein the leader charger further comprises:
linear charging control circuitry adapted to control a charging transistor coupled between the leader output and at least one battery pack; and
battery current sensing circuitry adapted to be coupled to at least one current sensor coupled in series with the at least one battery pack.

11. The leader charger for use in a scalable battery charger system of claim 9 wherein the DC-DC converter leader phase is selected from the group consisting of: a buck converter, a boost converter, a buck-boost converter, and a charge pump.

12. The leader charger for use in a scalable battery charger system of claim 9 wherein the leader-follower communication interface is configured to provide a demand signal from the leader charger to one or more follower chargers.

13. A follower charger for use in a scalable battery charger system, the follower charger comprising:
an input that receives at least one follower input voltage;
one or more DC-DC converter follower phases that receive the at least one follower input voltage and operates one or more switching devices of the DC-DC converter follower phases to generate a regulated output in cooperation with one or more external components coupled to the at least one follower charger;
follower control circuitry that operates the one or more DC-DC converter follower phases to regulate the follower output; and
a leader-follower communication interface that couples the follower control circuitry to a leader charger.

14. The follower charger for use in a scalable battery charger system of claim 13 wherein the one or more DC-DC converter follower phases are selected from the group consisting of: a buck converter, a boost converter, a buck-boost converter, and a charge pump.

15. The follower charger for use in a scalable battery charger system of claim 13 wherein the leader-follower communication interface is configured to receive a demand signal from a leader charger.

16. A scalable battery charger system comprising:
one or more charger modules, each charger module further comprising:
control circuitry including outer control circuitry operable as a leader controller and inner control circuitry, the outer control circuitry being selectively enabled to operate as a leader controller or selectively disabled or bypassed, and the inner control circuitry being operable as a follower controller under the direction of a leader controller, wherein the leader controller can be part of a same charger module of the one or more charger modules or a different charger module of the one or more charger modules; and
one or more switching devices operable by the control circuitry in cooperation with one or more external components to produce a regulated output and configurable with the one or more external components to operate as at least a buck converter or a boost converter; and
wherein multiple charger modules of the one or more charger modules are combinable to provide one or more of increased output current and increased output voltage.

17. The scalable battery charger system of claim 16 comprising a single charger module configured as a buck converter.

18. The scalable battery charger system of claim 16 comprising two charger modules coupled together as a buck-boost converter, wherein a first charger module is configured as a buck stage, and a second charger module is configured as a boost stage.

19. The scalable battery charger system of claim 18 wherein the two charger modules are contained within a single package.

20. The scalable battery charger system of claim 18 wherein the outer control circuitry of the second charger module is disabled or bypassed, and the inner control circuitry of the second charger module receives a demand signal from the outer control circuitry of the first charger module.

21. The scalable battery charger system of claim 16 comprising two charger modules including a first charger module and a second charger module coupled together as a two-phase buck converter.

22. The scalable battery charger system of claim 21 wherein the two charger modules are contained within separate packages.

23. The scalable battery charger system of claim 21 wherein the outer control circuitry of the second charger module is disabled or bypassed, and the inner control circuitry of the second charger module receives a demand signal from the outer control circuitry of the first charger module.

24. The scalable battery charger system of claim 16 comprising four charger modules coupled together as a two-phase buck-boost converter, wherein first and second charger modules are coupled together as a first buck-boost converter phase and third and fourth charger modules are coupled together as a second buck-boost converter phase.

25. The scalable battery charger system of claim 24 wherein the first and second buck-boost converter phases are contained within separate packages.

26. The scalable battery charger system of claim 24 wherein the outer control circuitry of the second, third, and fourth charger modules are disabled or bypassed, and the inner control circuitry of the second, third, and fourth charger module receive demand signals from the outer control circuitry of the first charger module.

27. The scalable battery charger system of claim 16 wherein the control circuitry of each charger module is contained on a respective single controller die.

28. The scalable battery charger system of claim 27 wherein the one or more switching devices of each charger module are contained on separate dies from the respective single controller dies.
